(19) United States
(12) Patent Application Publication
(10) Pub. No.: US 2017/0129601 A1
(43) Pub. Date: May 11, 2017

(54) DRONE HAVING A COUPLED PROPULSION SUPPORT

(71) Applicant: PARROT DRONES, Paris (FR)

(72) Inventors: Mathieu Babel, Paris (FR); Flavien Morra, Pantin (FR)

(21) Appl. No.: 15/345,292

(22) Filed: Nov. 7, 2016

(30) Foreign Application Priority Data
Nov. 10, 2015 (FR) 15 60735

(51) Int. Cl. B64C 39/02; B64C 27/08

(52) U.S. Cl. CPC B64C 39/024; B64C 27/08; B64C 2201/027; B64C 2201/042; B64C 2201/108; B64C 2201/146

(57) ABSTRACT

The invention relates to a rotary-wing drone (10) comprising a drone body (30) that comprises an electronic circuit board controlling the flight of the drone, four link arms (36) comprising a propulsion unit (38) at their ends, two propulsion units each having a propeller (12) that rotates in the clockwise direction and two propulsion units each having a propeller that rotates in the anticlockwise direction, the propulsion units that have propellers that rotate in the same direction being positioned on the same diagonal line. The drone comprises a propulsion support (32) comprising the link arms (36) and a central hub (34), two pairs of symmetrical link arms each extending on either side of the central hub, the central hub (34) being capable of being coupled to the drone body (30), and the propulsion support (32) having at least one torsional bending direction extending in the horizontal plane.

The invention relates to motorised flying machines such as drones, in particular rotary-wing drones of the quadcopter type.

The AR.Drone 2.0 or the Bebop Drone by Parrot SA, France are rotary-wing drones of the quadcopter type. They are equipped with a series of sensors (accelerometers, 3-axis gyrometers, altimeters) and may comprise at least one front video camera that captures an image of the landscape towards which the drone is directed. These drones are provided with multiple rotors that are each driven by a motor that can be controlled individually in order to control the attitude and speed of the drone. A rotary-wing drone of this type is also described in EP 2 937 123.

These quadcopters are equipped with four propulsion units that are each provided with a propeller. The propellers on two propulsion units rotate in the clockwise direction and the propellers on the other two propulsion units rotate in the anticlockwise direction. The propulsion units equipped with propellers that rotate in the same rotational direction are positioned on the same diagonal line.

Each propeller exerts traction on the drone due to the lift of the propeller, this traction being directed upwards, and a torque that is in the opposite direction to the rotational direction of said propeller. In stationary flight, i.e. when the drone is seemingly being kept motionless in altitude and attitude, the four propellers rotate at the same speed and the four lift forces are combined and compensate for the weight of the drone. In terms of the torques of the propellers, they cancel each other out due to the opposing rotational directions of the propellers.

WO 2010/061099 A2, EP 2 364 757 A1 and EP 2 450 862 A1 (Parrot) describe the principle of flying a drone by means of a mobile telephone or tablet having a touch screen and integrated accelerometers, for example an iPhone or an iPad (registered trademarks).

There are four commands produced by the control device, namely roll, i.e. the rotational movement about its longitudinal axis, pitch, i.e. rotational movement about the transverse axis, heading, also referred to as yaw. i.e. the direction in which the drone is oriented, and vertical acceleration.

It has been noted that turning the drone onto a yaw or holding the yaw results in sharp acceleration of the propulsion units, in particular during disturbances, for example due to wind. In cases such as this, it is not uncommon for the capacities of the propulsion units to reach their limits and for the drone to therefore go off yaw.

Indeed, when a yaw command is sent to the drone, the propulsion units that have the propellers rotating in one direction rotate more rapidly, i.e. the propulsion units accelerate, while the two other propulsion units rotate more slowly.

In this way, the sum of the lift forces compensates for the weight of the drone, but the sum of the torques is no longer zero and therefore the drone turns onto a yaw. Turning the drone to the right or the left onto a yaw is dependent on the two diagonal propulsion units that are required to accelerate their rotation.

In terms of the effectiveness of a command, it is noted that in the described quadcopter drones, the command to turn onto a yaw is less effective than the roll and pitch commands.

The effectiveness of a command can be calculated by measuring the angular acceleration generated on the drone for a set rotational speed of the propellers. The effectiveness is therefore expressed in radians per second squared per revolutions per minute (rad/s²/rpm).

For example, the effectiveness of the commands measured on the same drone indicates that the roll command has an effectiveness of 0.10 rad/s²/rpm and the pitch command has an effectiveness of 0.06 rad/s²/rpm, whereas the yaw command has an effectiveness of 0.0035 rad/s²/rpm. Therefore, a factor of 20 between the effectiveness of the yaw and the other commands has been observed.

The lack of effectiveness of the yaw command on the drones is due to torque differences and a high drag coefficient of the propeller.

Therefore, moving the drone onto a yaw requires 20 times more power on the propulsion units, in particular in terms of rotational speed, than the same movement on the pitch axis, meaning that the propulsion units are very often at their maximum when moving the drone onto a yaw.

One known solution allowing the effectiveness of the yaw command to be improved involves a structural modification to the framework of the drone, in particular by using what is known as a “VTail” shape at the rear of the drone relative to the main flight direction of the drone. The framework is modified such that the two propellers that are positioned at the rear relative to the main flight direction of the drone are not positioned horizontally, but are each at an angle of from 10 to 30° relative to the horizontal, and the link arms supporting the propulsion units at their ends form a V shape.

Owing to this V shape of the arms supporting the propulsion units, the thrust of the propellers is no longer vertical. Since the propellers positioned at the rear of the drone produce an oblique air flow, the commands to turn onto a yaw are improved.

For a given quadcopter drone, the thrust and the torque generated by the drag of the propeller under average flight conditions, i.e. at 8000 revolutions per minute, are 1.33 N and 13.3 mN·m, respectively.

With an axis inclined by an angle α relative to the vertical axis of the drone and a length of the link arms I, the torque generated when turning onto a yaw for a thrust P is:

Torque=P×I×sin(α)

If the angle α is 10° and the length of the link arms is 15 cm, the torque generated when turning onto a yaw is 34 mN·m. Therefore, due to the creation of an angle of 10° of the two rear link arms of the drone, the torque generated when turning onto a yaw by the thrust of the propeller is almost 2.5 times greater than the torque generated by the same propellers in a horizontal position. Therefore, the ability to control the turning onto a yaw is improved.

However, this solution has a drawback. This is because, when the drone is in stationary flight, some of the thrust of the inclined propellers cannot counteract the weight of the drone. Indeed, the sum of the four lift forces of the propellers on a drone of this type is less than the sum of the four lift forces of the propellers when the propellers are on a horizontal plane, and therefore, in order to compensate for the weight of said drone, the propulsion units thereof have to rotate at a greater rotational frequency and therefore the autonomy of the drone is reduced.

The object of the invention is to overcome this drawback by proposing a drone that makes it possible to improve the ability to control said drone during a command for turning onto a yaw without losing autonomy.

For this purpose, the invention proposes a rotary-wing drone comprising a drone body that comprises an electronic circuit board controlling the flight of the drone, four link arms each comprising a propulsion unit at their ends, two propulsion units each having a propeller that rotates in the clockwise direction and two propulsion units each having a propeller that rotates in the anticlockwise direction, the propulsion units that have propellers that rotate in the same direction being positioned on the same diagonal line.

The drone is characterised in that it comprises a propulsion support comprising the link arms and a central hub, two pairs of symmetrical link arms each extending on either side of the central hub, the central hub being capable of being coupled to the drone body, and the propulsion support having at least one torsional bending direction extending in the horizontal plane.

According to various additional features:
the central hub comprises a cut-out;
the central hub has an elongate shape having a pair of arms at each end, and the torsional bending direction is the longitudinal axis of the central hub;
the propulsion support comprises deformable coupling means, said deformable coupling means being capable of being attached to the drone body;
the propellers of the propulsion units are in a substantially horizontal plane;
the torsional bending direction is the main flight axis of the drone;
the propulsion support is made of an elastically deformable material at least in part;
the propulsion support is capable of torsionally deforming by an angle of between 3° and 10° as a result of a maximum predetermined value of a controlled thrust differential between the propellers on one diagonal line and the propellers on the other diagonal line;
the capacity for the central hub to twist in the bending direction is greater than the capacity for the arms to twist in the bending direction.

An embodiment of the present invention will now be described with reference to the accompanying drawings, in which:

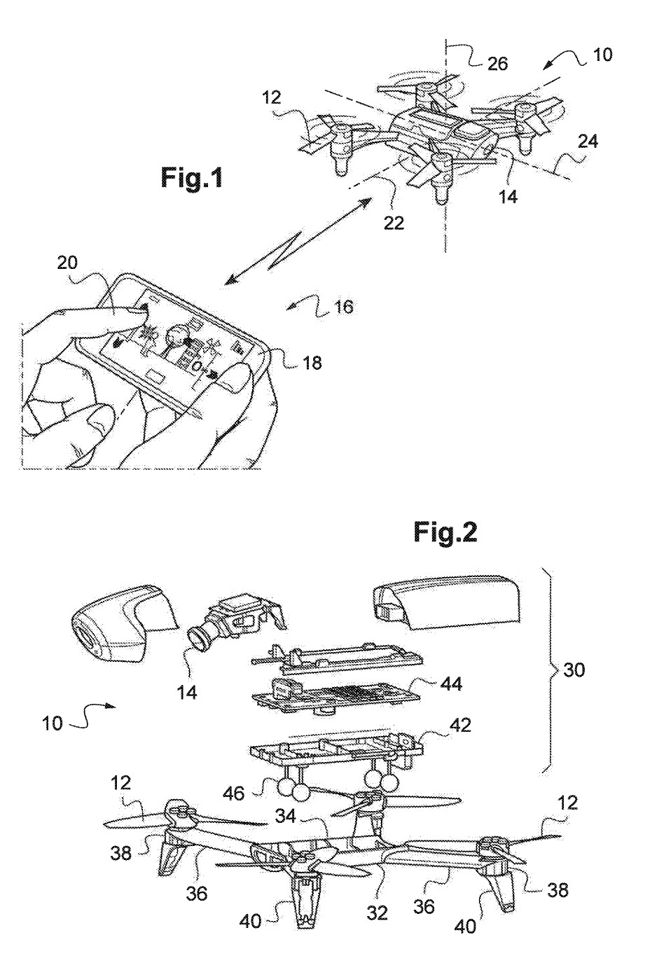

FIG. 1 is an overall view showing the drone and the associated control device for flying said drone;

FIG. 2 is a detailed view of the drone according to the invention;

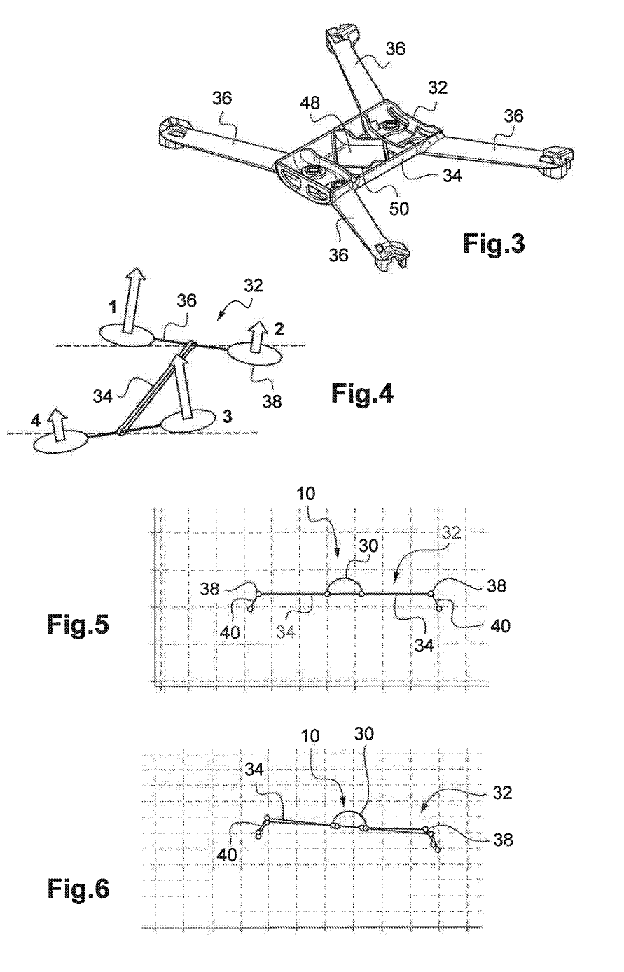

FIG. 3 is a detailed view of the propulsion support of the drone according to the invention;

FIG. 4 illustrates the torsional bending of the propulsion support during a command to turn onto a yaw according to the invention;

FIG. 5 shows the structure of the drone in stationary flight; and

FIG. 6 shows the structure of the drone during a command to turn onto a yaw according to the invention.

An embodiment of the invention will now be described.

In FIG. 1, reference sign 10 generally denotes a drone. According to the example shown in FIG. 1, this is a quadcopter-type drone such as the Bebop Drone model by Parrot SA, Paris, France.

The quadcopter drone comprises four coplanar propellers 12, the propulsion units of which are controlled separately by an integrated navigation and attitude-control system.

For this, the quadcopter drone is equipped with four propulsion units each provided with a propeller 12. The propellers on two propulsion units rotate in the clockwise direction and the propellers on the other two propulsion units rotate in the anticlockwise direction. The propulsion units equipped with propellers that rotate in the same rotational direction are positioned on the same diagonal line.

The drone 10 also comprises a front-view camera 14 for capturing an image of the landscape towards which the drone is directed. The drone also comprises a vertical-view camera (not shown) pointing downwards, which can capture successive images of the terrain over which the drone is flying, and is used in particular to analyse the speed of the drone relative to the ground.

According to an embodiment, the drone is also equipped with inertial sensors (accelerometers and gyrometers) for measuring, to a particular degree of precision, the angular speeds and the attitude angles of the drone, i.e. the Euler angles (pitch φ, roll θ and yaw ψ) describing the inclination of the drone relative to a horizontal plane of a fixed point of reference on the ground, with the understanding that the two longitudinal and transverse components of the horizontal velocity are closely linked to the inclination along the two axes of pitch and roll, respectively.

An ultrasound distance indicator arranged under the drone also provides a measurement of the altitude relative to the ground.

The drone 10 is controlled by a remote control device 16 such as a mobile telephone or tablet having a touch screen and integrated accelerometers, for example an iPhone (registered trademark) or similar, or an iPad (registered trademark) or similar. This device is a standard device that has not been modified except for a custom software application having been downloaded in order to control the flight of the drone 10. According to this embodiment, the user controls the movement of the drone 10 in real time using the control device 16.

The remote control device 16 is an apparatus provided with a touch screen 18 that displays the image of the landscape captured by the camera 14 on board the drone 10, having a number of symbols overlaid to allow commands to be activated by a user simply touching the symbols displayed on the touch screen 18 with their finger 20.

The control device 16 communicates with the drone 10 via a bidirectional exchange of data by means of a wireless connection of the local WiFi network type (IEEE 802.11) or Bluetooth (registered trademarks), namely from the drone 10 to the control device 16, in particular for transmitting the image captured by the camera, and from the control device 16 to the drone 10 to send flying commands.

Flying the drone 10 involves maneuvering it by means of:

a) rotation about a pitch axis 22 to make the drone move forwards or backwards; and/or
b) rotation about a roll axis 24 to move the drone to the right or the left; and/or
c) rotation about a yaw axis 26 to make the main axis of the drone, i.e. the direction in which the front camera is pointing and the direction of movement of the drone, pivot towards the right or the left; and/or
d) translation downwards 28 or upwards 30 by changing the power level, so as to respectively reduce or increase the altitude of the drone.

The command to turn onto a yaw is carried out on the drone by making a pair of propulsion units of which the propellers rotate in the same direction rotate slightly faster, and making the other pair of propulsion units rotate slightly slower.

In order to improve the effectiveness of the command to turn onto a yaw, the structure of the drone is modified as described below with reference to FIGS. 2 and 3.

FIG. 2 shows the drone 10, including a drone body 30 and a propulsion support 32.

The propulsion support 32 comprises a central hub 34 rigidly connected to four link arms 36 extending from the central hub 34. Each connecting arm is equipped at its distal end with a propulsion unit 38 comprising a motor that rotates a propeller 12. Two propulsion units each have a propeller that rotates in the clockwise direction and two propulsion units each have a propeller that rotates in the anticlockwise direction, the propulsion units that have propellers that rotate in the same direction being positioned on the same diagonal line.

In the lower region, the propulsion unit 38 is extended by a drone support 40 that forms a foot, by means of which the drone can rest on the ground when it is idle.

According to another embodiment, the drone support(s) 40 is/are attached to the propulsion support 32, in particular to the central hub 34 or the link arm 36.

According to the invention, two pairs of symmetrical link arms 36 each extend on either side of the central hub 34.

The drone body 30 comprises a mounting plate 42 that is intended to receive the electronic circuit board 44, which carries almost all of the electronic components of the drone, including the inertial navigation system, and is intended to receive wireless communication means. The mounting plate 42 is in the form of a one-piece element that is made of light metal material and acts as a cooler for dissipating the excess calories from certain components that generate a large amount of heat, such as the main processor, the radio chip, the MOSFETs for switching the motors on and off, etc.

According to the invention, the central hub 34 of the propulsion support 32 is capable of being coupled to the drone body 30.

According to a particular embodiment, the propulsion support 32 comprises deformable coupling means 46, said deformable coupling means 46 being capable of being attached to the drone body 30.

The deformable coupling means 46 are elastomer units, for example.

As shown in FIGS. 1 and 2, the propellers of the propulsion units are in a substantially horizontal plane.

FIG. 3 is an enlarged view of the propulsion support 32, having a central hub 34 and two pairs of symmetrical link arms 36 extending on either side of the central hub 34.

According to an embodiment, the central hub 34 has an elongate shape having a pair of arms at each end. According to this embodiment, the torsional bending direction of the propulsion support 32 is the longitudinal axis of the central hub.

According to another embodiment, the central hub 34 has a round or square shape, around which the link arms 36 are distributed.

The propulsion support 32 is in particular made at least in part of an elastically deformable material, in particular of polyamide, for example PA12, in which glass fibre is integrated, for example in a quantity of 20%. The glass fibre has the advantage of making the structure of the propulsion support lighter while reinforcing the structure of the support.

Preferably, the modulus of elasticity of the material of the propulsion support is approximately 3500 MPa.

According to the invention, the propulsion support 32 has at least one torsional bending direction extending in the horizontal plane. This deformation of the support is particularly advantageous when a command to turn onto a yaw is being carried out, and improves the effectiveness of the command to turn onto a yaw while preventing any negative impact on the autonomy of the drone.

In a view of the propulsion support 32 equipped with a central hub 34 and with four link arms 36 each having a propulsion unit 38 at the distal end thereof, FIG. 4 shows the deformation of the propulsion support that takes place when the command to turn onto a yaw is being carried out.

The deformation of the structure of the propulsion support 32 has the effect of offsetting the thrusts of the propellers of the propulsion units 38. In particular, the thrusts of the propellers of different propulsion units are no longer vertical, but are at an angle that produces oblique thrusts.

The deformation caused to the structure of the propulsion support 32 is symmetrical along the central vertical axis of the propulsion support.

In order for the deformation of the structure of the propulsion support to contribute to the effectiveness of the command to turn onto a yaw, the rotational direction of the propulsion units is determined in the following way. According to the invention, a rotation command in the clockwise direction generates deformation of the structure and results in an increase in the rotational speed of the propulsion units 1 and 3 and a reduction in the rotational speed of propulsion units 2 and 4 as shown in FIG. 3. In order to improve the effectiveness of the command to turn onto a yaw, the propellers of the propulsion units 1 and 3 need to rotate in the anticlockwise direction.

Otherwise, the deformation of the structure counteracts the torque generated by the drag of the propellers, and therefore the effectiveness of the command to turn onto a yaw is reduced.

According to the invention, the four propulsion units 38 of the propulsion support 32 contribute to the command to turn onto a yaw being carried out when the structure deforms, thus improving the effectiveness of the command without reducing the autonomy of the drone.

In order to again improve the effectiveness of the command to turn onto a yaw, it is advantageous to make it easier for the propulsion support, in particular the central hub 34, to bend torsionally. To do this, the central hub 34 can have at least one cut-out 48 as shown in FIG. 3.

Preferably, the torsional bending direction of the propulsion support 32 is the main flight axis of the drone.

In addition, according to a particular embodiment, the capacity for the central hub to twist in the bending direction is greater than the capacity for the arms to twist in the bending direction.

As shown in FIG. 3, when the central hub 34 has a large cut-out 48 in the central part, it may be advantageous to reinforce the structure of the central hub, in particular against shocks, by means of reinforcement elements 50.

FIG. 5 is a front view during stationary flight of the propulsion support 32 of the drone 10, in particular the four link arms 36 each having, at the distal end thereof, a propulsion unit 38 and a drone support 40 under the propulsion unit. It can be seen that all of the link arms 36 of the propulsion support of the drone are in a substantially horizontal plane.

FIG. 6 shows the deformation of the propulsion support 32 according to the invention while a command to turn onto a yaw of the drone is being carried out.

According to the invention and according to an embodiment, the propulsion support 32 is capable of torsionally deforming by an angle of between 3° and 10° as a result of a maximum predetermined value of a controlled thrust differential between the propellers on one diagonal line and the propellers on the other diagonal line.

In the embodiment in FIG. 6, an angle of approximately 4.7° can be seen between the link arms 36 located at the front of the drone in the main movement direction of the drone and the link arms 36 located at rear of the drone.

The effectiveness of the command to turn onto a yaw was measured on two drones according to the invention having respective propulsion supports of different levels of rigidity.

The effectiveness of the command to turn onto a yaw of a first drone according to the invention demonstrated that when the rotational direction of the propellers 1 and 3 as shown in FIG. 4 is anticlockwise, the effectiveness of the measured command is 0.004 rad/s²/rpm, and, by contrast, if the propellers are mounted in the clockwise direction, the effectiveness of the measured command is 0.003 rad/s²/rpm.

A second test was carried out on a second drone according to the invention having a propulsion support of a lower rigidity than the first drone. This test demonstrated that when the rotational direction of the propellers 1 and 3 as shown in FIG. 4 is anticlockwise, the effectiveness of the measured command is 0.005 rad/s²/rpm, and, by contrast, if the propellers are mounted in the clockwise direction, the effectiveness of the measured command is 0.002 rad/s²/rpm.

This demonstrates that the effectiveness of the command to turn onto a yaw is improved all the more when the propulsion support has a good level of torsional bending in the horizontal plane, in particular in the main flight direction of the drone.

1. Rotary-wing drone (10) comprising
a drone body (30) that comprises an electronic circuit board controlling the flight of the drone,
four link arms (36) each comprising a propulsion unit (38) at their ends, two propulsion units each having a propeller (12) that rotates in the clockwise direction and two propulsion units each having a propeller that rotates in the anticlockwise direction, the propulsion units that have propellers that rotate in the same direction being positioned on the same diagonal line, characterised in that it comprises a propulsion support (32) comprising the link arms (36) and a central hub (34), two pairs of symmetrical link arms each extending on either side of the central hub, the central hub (34) being capable of being coupled to the drone body (30), and the propulsion support (32) having at least one torsional bending direction extending in the horizontal plane.

2. The rotary-wing drone according to claim 1, characterised in that the central hub comprises a cut-out (48).

3. The rotary-wing drone according to claim 1, characterised in that the central hub (34) has an elongate shape having a pair of arms at each end, and the torsional bending direction is the longitudinal axis of the central hub.

4. The rotary-wing drone according to claim 1, characterised in that the propulsion support (32) comprises deformable coupling means (46), said deformable coupling means being capable of being attached to the drone body.

5. The rotary-wing drone according to claim 1, characterised in that the propellers (12) of the propulsion units are in a substantially horizontal plane.

6. The rotary-wing drone according to claim 1, characterised in that the torsional bending direction is the main flight axis of the drone.

7. The rotary-wing drone according to claim 1, characterised in that the propulsion support (32) is made of an elastically deformable material at least in part.

8. The rotary-wing drone according to claim 1, characterised in that the propulsion support is capable of torsionally deforming by an angle of between 3° and 10° as a result of a maximum predetermined value of a controlled thrust differential between the propellers on one diagonal line and the propellers on the other diagonal line.

9. The rotary-wing drone according to claim 1, characterised in that the capacity for the central hub to twist in the bending direction is greater than the capacity for the arms to twist in the bending direction.

10. The rotary-wing drone according to claim 2, characterised in that the central hub (34) has an elongate shape having a pair of arms at each end, and the torsional bending direction is the longitudinal axis of the central hub.

11. The rotary-wing drone according to claim 4, characterised in that the propellers (12) of the propulsion units are in a substantially horizontal plane.

12. The rotary-wing drone according to claim 11, characterised in that the propulsion support (32) is made of an elastically deformable material at least in part.

13. The rotary-wing drone according to claim 12, characterised in that the propulsion support is capable of torsionally deforming by an angle of between 3° and 10° as a result of a maximum predetermined value of a controlled thrust differential between the propellers on one diagonal line and the propellers on the other diagonal line.

14. The rotary-wing drone according to claim 5, characterised in that the torsional bending direction is the main flight axis of the drone.
